(19) United States
(12) Patent Application Publication
(10) Pub. No.: US 2024/0240069 A1
(43) Pub. Date: Jul. 18, 2024

(54) POLYMERIZATION OF A SILANE-MODIFIED POLYMER, WHICH IS PRODUCED BY MEANS OF A RADICAL CHAIN POLYMERIZATION, IN A POLYOL OR IN A PREPOLYMER WITH TERMINAL ISOCYANATE GROUPS, AND USE THEREOF IN POLYURETHANE FORMULATIONS

(71) Applicant: FOLLMANN GMBH & CO. KG, Minden (DE)

(72) Inventors: Anton KLEMUSCH, Minden (DE); Christine ZWEIGERT, Minden (DE)

(21) Appl. No.: 18/556,630

(22) PCT Filed: Apr. 22, 2022
(86) PCT No.: PCT/EP2022/060648

§ 371 Date: Oct. 20, 2023

(30) Foreign Application Priority Data
Apr. 23, 2021 (DE) 10 2021 110 428.9
Jul. 23, 2021 (DE) 10 2021 119 133.5

(51) Int. Cl. C09J 175/08; C08F 2/38; C08F 283/00; C08G 18/10; C09J 7/35

(52) U.S. Cl. CPC C09J 175/08; C08F 2/38; C08F 283/006; C08G 18/10; C09J 7/35; C08G 2150/00; C08G 2170/20; C08G 2190/00; C09J 2301/304; C09J 2475/00

(57) ABSTRACT

The present invention relates to a process for the production of a polymer composition in which a silane-modified ethylene-based polymer, which is preferably a silane-modified acrylate polymer, is polymerized in a polyol or in a prepolymer having isocyanate terminal groups, and to a polymer composition produced by this process. The invention further relates to a process for the production of a moisture-hardening polyurethane hot-melt adhesive composition and a 1K polyurethane adhesive, based on the polymer composition of the invention together with the moisture-hardening polyurethane hot-melt adhesive composition produced therewith and the 1K polyurethane adhesive.

The present invention relates to a process for the production of a polymer composition in which a silane-modified polymer is polymerized by radical chain polymerization with ethylenically unsaturated monomers in a polyol or in a prepolymer with terminal isocyanate groups, and a polymer composition produced by this process. The invention further relates to a process for the production of a moisture-hardening polyurethane hot-melt adhesive composition and a 1K polyurethane adhesive, based on the polymer composition of the invention together with the moisture-hardening polyurethane hot-melt adhesive composition produced therewith and the 1K polyurethane adhesive.

### BACKGROUND OF THE INVENTION

Depending on use, e.g., adhesives require a long open time because the joining process is often performed manually. At the same time, quick adhesion is required after joining because the joined parts need to be processed further as quickly as possible. In polyurethane adhesives, this dilemma is solved, e.g., through the use of acrylate polymer in powder form in polyether-based polyurethane. The latter enables a long open time, while the acrylate polymer ensures high initial adhesion. Incorporating the acrylates is often problematic because they add a lot of air and are difficult to dissolve. The solution is to polymerize the acrylate polymers directly in a polyol, which is then converted into polyurethane. This process also enables the use of acrylate polymers whose glass transition temperatures are below room temperature. Furthermore, these can be modified as needed with co-monomers. However, the characteristics of the adhesives are limited because the acrylate polymer is a thermoplastic, which softens at higher temperatures or sometimes has a lower resistance to certain chemicals.

In summary, the resistance of reactive adhesives to temperature and certain chemicals is weakened by the use of thermoplastic materials such as acrylate polymers. Furthermore, adhesion of inorganic materials without surface treatment with polyurethane adhesives causes adhesion issues.

U.S. Pat. No. 5,021,507 A pertains to acrylic-modified reactive urethanes and teaches in column 2, lines 58 to 68 that for ethylenically unsaturated monomers with moisture-reactive functional groups, the monomers must be added only after the prepolymer has been formed and then polymerize only by means of free-radical polymerization.

Further prior art can be found in U.S. Pat. No. 5,018,337, WO 2016/123418 A1, or WO 01/81495 A2.

The present invention is based on the object of improving the prior art or offering an alternative.

### SUMMARY OF THE INVENTION

According to a first aspect of the present invention, the issue is solved by means of a process for the preparation of a polymer composition according to claim 1. Further embodiments are the subject of the further independent and dependent claims.

In a first aspect, the invention relates to a process for the production of a polymer composition, which comprises the following steps:
a) Combining:
   (i) a polyol or a prepolymer with terminal isocyanate (NCO) groups
   (ii) an ethylenically unsaturated monomer containing no active hydrogen and having no moisture-reactive functional groups (monomer type A), and
   (iii) an ethylenically unsaturated, non-active hydrogen-containing monomer with a moisture-reactive functional group (type B monomer);
b) polymerizing the mixture from step (a) using a radical polymerization process with a chain transfer agent to obtain a low-molecular-weight polymer;
c) optional heating of the mixture from step (b) to a temperature of 100-160° C. for 10-60 minutes to partially crosslink the polyol or the prepolymer with terminal NCO groups with the low-molecular-weight polymer.

In terms of terminology, the following should be explained:

The ethylenically unsaturated group allows the radical polymerization of the monomers to form a polymer. The absence of active hydrogen in the monomers ensures that the monomers do not take part in the subsequent additive reaction to form the polyurethane. Monomer type A contributes to the structure of the polymer chain, monomer type B allows, through the moisture-reactive group, a reaction with the polyol or the isocyanate groups of the prepolymer, with the moisture-reactive groups of the polymer or in the application, such as with inorganic substrates to improve adhesion on these substrates.

The polymer according to the invention produced using monomers with ethylenically unsaturated groups, which is preferably an acrylate polymer, is also referred to below as an ethylene-based polymer.

By modifying the ethylene-based polymer, which is preferably an acrylate polymer, with silanes they can react with moisture after application and are thereby crosslinked. This leads to an increase in resistance to heat and certain chemicals. In addition, silanes react with inorganic materials, such as glass or metal, thereby increasing adhesion to them. This also means that the area of application of these adhesives can be expanded. Through application of additional heat, crosslinking can be accelerated and a permanently sticky adhesive polymer film is formed. Furthermore, it is also possible to produce reactive adhesives that do not contain any monomeric isocyanates and are therefore not subject to labeling requirements. This enables safe handling of the adhesives and does not require any laborious measures during use.

The polymers can be used for adhesives, sealants, and coatings, reactive hot melt adhesives, textile adhesives, adhesives for the wood & furniture sector, automotive adhesives, adhesives in the construction sector, liquid 1K adhesives, sealants, primers, and coatings.

The basic technical idea of the invention is based on the modification of ethylene-based polymers and, in particular, acrylate polymers with silanes in order to improve the characteristics profile. Possible improvements could be the following:
Increase of temperature resistance through crosslinking of the silanes.
A reaction of the silanes with inorganic substrates to improve adhesion to them.
Possible production of products with isocyanate monomer concentrations below 0.1%, which are therefore not subject to labeling requirements.

The invention has several advantages over the prior art. Thermoplastic acrylate polymers are converted into reactive polymers that react with moisture to form thermosets and therefore have greater resistance to heat and special chemicals. Since the silane groups are randomly distributed across the polymer and not just terminal, as is the case with polyaddition products or subsequent silanization, the crosslinking density and thus the durability of the material is increased. Silanes also offer the possibility of reacting with inorganic materials, such as glass or metals in order to increase the adhesion strength to these materials, which expands the adhesion spectrum or enables the adhesion of inorganic materials to organic materials such as plastics. Furthermore, three synthetic pathways are available, which also allow the production of materials without isocyanate monomers. This means that these products are not subject to labeling requirements or any restrictions.

The present polymer composition can be used as a novel intermediate for the production of various polyurethanes. In particular, the following options are rendered:
Preparation of a silane-modified ethylene-based polymer (preferably as an acrylate polymer) in a polyol or in a prepolymer with terminal NCO groups, with subsequent reaction of the polyol or the prepolymer with terminal NCO groups to form a thermoplastic polyurethane.
Preparation of a silane-modified ethylene-based polymer (preferably as an acrylate polymer) in a polyol or in a prepolymer with terminal NCO groups, with subsequent reaction of the polyol or the prepolymer with terminal NCO groups to form a thermoplastic polyurethane.
Preparation of a silane-modified ethylene-based polymer (preferably as an acrylate polymer) in a polyol or in a prepolymer with terminal NCO groups, with subsequent reaction of the polyol or the prepolymer with terminal NCO groups to form a reactive polyurethane, which is then reacted with aminosilanes or mercaptosilanes to form a silane-terminated polyurethane.

### INVENTION IN DETAIL

The polymerization according to the invention of monomer type A with monomer type B is generally carried out by combining all monomers into the reaction vessel and allowing them to react randomly according to their relative concentrations and relative reactivity, enabling the formation of statistical polymers. However, to increase or reduce the non-uniformity of the polymers, one or more of the ethylenically unsaturated monomers can also be added during polymerization.

Alternatively, the monomers of monomer type A and monomer type B can be added gradually, so that the radical polymerization is started after addition of a defined mixture of monomer type A and monomer type B, and only after polymer formation, which is accompanied by almost complete consumption of the monomers, is a defined mixture of monomer type A and monomer type B added to the reaction mixture again. The step-by-step addition prevents the reaction mixture from overheating due to the exothermic polymerization reaction.

The radical polymerization process is preferably carried out at a temperature of less than 100° C., further preferably at a temperature of 40-95° C., and particularly preferably at a temperature of 80-90° C.

It is preferred here if the weight ratio of monomer type A and monomer type B defined in the first step is also maintained in the second addition.

It is also conceivable that the amount of monomer type A in the second step is greater than the amount of monomer type A in the first addition. The quantitative ratio of monomer type A_{first addition} to monomer type A_{second addition} is preferably between 1:1 and 1:10, further preferably between 1:2 and 1:8, and in particular preferable between 1:3 and 1:7.

Accordingly, it is conceivable that the amount of monomer type B in the second step is greater than the amount of monomer type B in the first addition. The quantitative ratio of monomer type B_{first addition} to monomer type B_{second addition} is preferably between 1:1 and 1:10, further preferably between 1:2 and 1:8, and in particular preferable between 1:35 and 1:7.

In the optional step (c) of the process, the mixture from step (b), which contains the low-molecular-weight polymer as a result of the radical polymerization, is heated so that the polyol or the prepolymer with terminal NCO groups is partially crosslinked with the low-molecular-weight polymer. Due to its moisture-reactive groups, the low-molecular-weight polymer can react with the hydroxyl groups of the polyol or the isocyanate groups of the prepolymer. This reaction results in a polymer composition with increased temperature resistance.

In the optional step (c), the silane groups can alternatively or additionally react with one another. This reaction also results in a polymer composition with increased temperature resistance.

According to the invention, a polyol or a prepolymer with terminal NCO groups is used in the process for the production of the polymer composition.

As it pertains to the polyol, this is to be understood as meaning that at least one polyol can be used here, i.e. also two, three, four, or even more polyols. Preferably, exactly one polyol is used in the process.

Expediently, the polyol used according to the invention has a water content of maximum 0.1% by weight and preferably maximum 0.05% by weight.

Suitable polyols are selected from the group consisting of polyester, hydroxyl group-containing polycaprolactone, polyoxyalkylene polyol (synonymous with the term “polyglycol”), monosubstituted glycol ester, polythioether, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy functional fats and oils, and mixtures thereof.

Diols, polyethylene oxides, or polypropylene oxides are particularly suitable.

Suitable polyols are, on the one hand, the high-molecular polyoxyalkylene polyols already mentioned, preferably polyethylene oxides or polyoxypropylene diols with a degree of unsaturation lower than 0.02 mEq/g and with a molecular weight in the range from 400-18,000 g/mol, in particular those with a molecular weight in the range from 1,000-4,000 g/mol. PPG 2000 or PPG 4000 are particularly suitable.

To achieve a higher crosslinking density, higher-quality alcohols such as triols and tetraols can also be used. Glycerin, trimethylolpropane, or pentaerythritol are mentioned here as examples.

Polyoxyalkylene polyols, which are also called polyether polyols, polyglycols or oligoetherols, are also suitable. These are polymerization products of ethylene oxide, 1,2-propylene oxide, 1,2- or 2,3-butylene oxide, oxetane, tetrahydrofuran or mixtures thereof, possibly polymerized with the help of a starter molecule with two or more active hydrogen atoms such as water, ammonia or compounds with one or more OH or NH groups such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerin, aniline, and mixtures of the aforementioned compounds.

Particularly suitable polyester polyols are those which are produced from dihydric to trihydric, especially dihydric, alcohols, such as, e.g., ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimerdiol), hydroxypivalic acid neopentyl glycol ester, glycerin, 1,1,1-trimethylolpropane or mixtures of the aforementioned alcohols, with organic di- or tricarboxylic acids, in particular dicarboxylic acids, or their anhydrides or esters, such as, e.g., succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, as well as polyester polyols from lactones such as from ε-caprolactone and starters such as the aforementioned di- or trihydric alcohols.

The use of polycarbonate polyols is also conceivable, as can be obtained by reacting, e.g., the alcohols mentioned above—used to form the polyester polyols—with dialkyl carbonates, diaryl carbonates, or phosgene.

Also suitable are polyhydroxy-functional fats and oils, e.g., natural fats and oils, especially castor oil, or polyols obtained by chemical modification of natural fats and oils-so-called oleochemical-, e.g., the epoxy polyesters or epoxy polyethers obtained by epoxidation of unsaturated oils and subsequent ring opening with carboxylic acids or alcohols, or polyols obtained by hydroformylation and hydrogenation of unsaturated oils, or polyols obtained from natural fats and oils by degradation processes such as alcoholysis or ozonolysis and subsequent chemical combination, e.g., by transesterification or dimerization, of the degradation products obtained in this way or derivatives thereof. Suitable degradation products of natural fats and oils are, in particular, fatty acids and fatty alcohols as well as fatty acid esters, in particular the methyl esters (FAME), which can be derivatized, e.g., by hydroformylation and hydrogenation to give hydroxy fatty acid esters.

It is also conceivable to use polyhydrocarbon polyols. These are also called oligohydrocarbonols and include, e.g., polyhydroxy-functional polyolefins, polyisobutylenes, polyisoprenes; polyhydroxy-functional ethylene-propylene, ethylene-butylene or ethylene-propylene-diene copolymers, such as are produced, e.g., by the company Kraton Polymers, polyhydroxy-functional polymers of dienes, in particular of 1,3-butadiene, which in particular can also be produced from anionic polymerization, polyhydroxy-functional copolymers of dienes such as 1,3-butadiene or diene mixtures and vinyl monomers such as styrene, acrylonitrile, vinyl chloride, vinyl acetate, vinyl alcohol, isobutylene, and isoprene, e.g., polyhydroxy-functional acrylonitrile/butadiene copolymers, such as those formed from epoxides or amino alcohols and carboxyl-terminated acrylonitrile/butadiene copolymers, and hydrogenated polyhydroxy-functional polymers or copolymers of dienes.

In addition to these mentioned polyols, small amounts of low-molecular-weight di- or polyhydric alcohols such as, e.g., 1,2-ethanediol, 1,2- and 1,3-propanediol, neopentylglycol, diethyleneglycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher alcohols, low-molecular-weight alkoxylation products of the above-mentioned dihydric and polyhydric alcohols, and mixtures of the above-mentioned alcohols are also used in the production of the polyurethane polymer containing isocyanate groups.

It is also conceivable that in addition to these polyols mentioned, small amounts of low-molecular-weight di- or polyvalent amines such as ethylenediamine, toluenediamine (TDA), diaminodiphenylmethane (DADPM), and polymethylene-polyphenylenamine or amino alcohols such as ethanolamine and diethanolamine, as well as mixtures of the aforementioned amines and amino alcohols are used in the production of the polyurethane polymer containing isocyanate groups.

A prepolymer with terminal NCO groups can also be used in the process for producing the polymer composition. This should be understood to mean that at least one corresponding prepolymer can be used here, including two, three, four, or even more prepolymers. Preferably, exactly one prepolymer with terminal NCO groups is used in the process.

According to one advantage, the prepolymer with terminal NCO groups may be provided to have a molar ratio of NCO to OH groups of between 1.5 to 1 and 2.0 to 1.

In one embodiment, the prepolymer with terminal NCO groups is prepared by reacting a diol with diisocyanate.

Suitable polyols are selected from the group consisting of polyester, polycaprolactone containing hydroxyl groups, polyglycols, monosubstituted glycol esters, polythioethers, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy-functional fats and oils, and mixtures thereof.

Diols, polyethylene oxides, or polypropylene oxides are particularly suitable.

Suitable polyols are, on the one hand, the high-molecular polyglycols already mentioned, preferably polyethylene oxides or polyoxypropylene diols with a degree of unsaturation lower than 0.02 mEq/g and with a molecular weight in the range from 400-18,000 g/mol, in particular those with a molecular weight in the range from 1,000-4,000 g/mol. PPG 2000 or PPG 4000 are particularly suitable.

A mixture of polyols can also be used here. Preferably, this is a mixture of two or more polyethylene oxides or a mixture of two or more polyoxypropylene diols. A mixture of PPG1000 and PPG 400 is particularly advantageous.

For the production of the prepolymer with terminal isocyanate groups, the diisocyanates familiar to qualified experts in the production of polyurethane polymers can be used.

It may further be possible that the diisocyanate for this prepolymer synthesis is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl 4,4′ diisocyanate, azobenzene 4,4′-diisocyanate, diphenyl sulfone 4,4′-diisocyanate, dichlorohexamethylene diisocyanate, furfurylidene diisocyanate, 1-chlorobenzene-2,4-diisocyanate, 1,3-bis(isocyanatomethyl)benzene, 1,3-bis(isocyanatomethyl)cyclohexane, block diisocyanates and carbodiimide-modified diisocyanates, and any mixtures of the above diisocyanates. Diphenylmethane diisocyanates are preferably used here and 4,4′-diphenylmethane diisocyanate (4,4′-MDI) is particularly preferred.

In the radical polymerization process, an initiator which is a peroxide initiator or an azo initiator can be used. Preferred initiators are dilauroyl peroxide, dibenzoyl peroxide, and azobis(isobutyronitrile). The use of dilauroyl peroxide is preferred.

It is also conceivable that an auxiliary and/or an additive is added to the reaction mixture in the process of the invention. Examples include surface-active substances, fillers, other flame retardants, nucleating agents, oxidation stabilizers, slip and demolding aids, dyes and pigments, optionally stabilizers, e.g. against hydrolysis, light, heat or discoloration, inorganic and/or organic fillers, reinforcing agents, and plasticizers. Suitable auxiliaries and additives can be found, e.g., in the Plastics Handbook, Volume 7 “Polyurethanes,” Gerhard W. Becker and Dietrich Braun, Carl Hanser Verlag, Munich, Vienna, 1993.

To adjust the viscosity, a solvent can also be added to the reaction mixture at any time in the process of the invention. Examples of solvents include triethyl phosphate (TEP), pentamethyldiethylenetriamine (PMDETA), triethylenediamine (TEDA), monoethylene glycol, polyethylene glycol and propylene carbonate (PC), and mixtures of two or more of the aforementioned solvents. In case the solvent is a polyol, adding it after completion of the radical polymerization is favorable.

To accelerate the reaction, a catalyst can be added to the reaction mixture in the process of the invention.

For example, suitable catalysts include N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PDMAFE), 1,4-diazadicyclo[2,2,2]octane (DABCO), 2-(2-dimethylaminoethoxy)ethanol (DMAFE), 2-((2-dimethylaminoethoxy)ethylmethylamino)ethanol, 1-(bis(3-dimethylamino)propyl)amino-2-propanol, N,N′,N″-tris(3-dimethylamino-propyl)hexahydrotriazine, dimorpholinodiethyl ether (DMDEE), N,N-dimethylbenzylamine, N,N,N′,N″,N′″-pentaamethyldipropylenetriamine, N,N′-diethylpiperazine. Particularly suitable are sterically hindered primary, secondary or tertiary amines such as dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-α-phenyethyl)amine, tris-n-propylamine, dicyclohexylamine, t-butylisopropylamine, di-t-butylamine, cyclohexyl-t-butylamine, de-sec-butylamine, dicyclopentylamine, di-α-trifluoromethylethyl)amine, di-(α-phenylethyl)amine, triphenylmethylamine, and 1,1-diethyl-n-propylamine. Other sterically hindered amines include morpholines, imidazoles, ether compounds such as dimorpholinodiethyl ether or dimorpholinodimethyl ether; N-ethylmorpholine, N-methylmorpholine, bis(dimethylaminoethyl) ether, imidizoles, nomethylimidazoles, 1,2-dimethylimidazoles, N,N,N′,N′,N″,N″-pentamethyldiethylenetriamine, N,N,N′,N′,N″,N″-pentaethyldiethylenetriamine, N,N,N′,N′,N″,N″-pentamethyldipropylenetriamine, bis(diethylaminoethyl)ether, and bis(dimethylaminopropyl)ether.

According to the invention, monomer type A is an ethylenically unsaturated monomer that does not contain active hydrogen and has no moisture-reactive functional groups.

According to the invention, a monomer of monomer type A is used in the process for producing the polymer composition. This should be understood to mean that at least one monomer of this type can be used here, i.e., also two, three, four, or even more type A monomers. Preferably, two monomers of monomer type A are used in the process.

Examples of monomer type A are selected from the group consisting of C1 to C12 esters of acrylic acid or methacrylic acid such as methyl acrylate, ethyl acrylate, n-butyl acrylate, methyl methacrylate, ethyl methacrylate, or n-butyl methacrylate, vinyl esters such as vinyl acetate, or vinyl propionate, vinyl ethers, fumarates, maleates, styrenes, acrylonitriles, ethylenes, or mixtures thereof.

Particularly suitable as monomer type A is n-butyl methacrylate or methyl methacrylate or a mixture thereof.

According to the invention, monomer type B is an ethylenically unsaturated monomer that does not contain active hydrogen and has a moisture-reactive functional group.

According to the invention, a monomer of monomer type B is used in the process for producing the polymer composition. This should be understood to mean that at least one monomer of this type can be used here, i.e., also two, three, four or even more type B monomers. Preferably, exactly one monomer of monomer type B is used in the process.

Furthermore, it is advantageous if, within the scope of the invention monomer type B is selected from the group consisting of vinyl compounds, acrylates, methacrylates, fumarates, maleates, styrenes, acrylonitriles, ethylenes, or mixtures thereof, all having a moisture-reactive functional group.

A suitable moisture-reactive group is the isocyanate group or the silane group. Monomer type B preferably has a silane group as a moisture-reactive group.

Advantageously, the invention may provide that monomer type B is selected from the group consisting of vinyltrichlorosilane, methylvinyldichlorosilane, vinyltriethoxysilane, vinyltrimethoxysilane, vinyltris(2-methoxyethoxy)silane, vinyltriacetoxy-silane, finylmethyldiethoxysilane, vinyldimethylmethoxysilane, vinyldimethylethoxysilane, vinylmethyldimethoxysilane, vinylmethyldiacetoxysilane, vinyltriisopropoxysilane, vinyltriiso-propenoxysilane, vinyltris(methyl ethyl ketoximino) silane, divinyltetramethyldisiloxane, tetra-vinyltetramethylcyclotetrasiloxane, 3-acryloxypropyldimethylmethoxysilane, 3-acryloxy-propyldimethylethoxysilane, 3-acryloxypropyltrimethoxysilane, 3-acryloxypropyltriethoxysilane, 3-methacryloxypropyltrimethoxysilane, 3-methacryloxypropyltriethoxysilane, 3-methyacryloxypropylmethyldiethoxysilane, 3-methyacryloxypropylmethyldimethoxysilane, 3-methacryloxypropyl-tris(2 methoxyethoxy)silane, 4-(3-trimethoxysilylpropyl)benzylstyrene sulfonate, allyl-triethoxysilane, allyltrimethoxysilane, and oligomers of these silanes.

Methacryloxypropyltrimethoxysilane is particularly suitable as monomer type B.

According to the invention, a chain transfer agent is used as part of the radical polymerization process in order to reduce the average degree of polymerization of the finished polymer and to obtain a low-molecular-weight polymer. Qualified experts are familiar with chain transfer agents for radical polymerizations.

It may be advantageous if, within the scope of the invention, the chain transfer agent is an organohalogen compound, an unsaturated aromatic compound or a thiol, preferably selected from the group consisting of tetrachloromethane, 2,4-diphenyl-4-methyl-1-pentene, dodecylmercaptan, thioglycolic acid, octylthioglycolate, and thioglycerol.

Preferably, the chain transfer agent is dodecyl mercaptan.

It is further conceivable that in the process for preparing the polymer composition, the polyol is provided in an amount of from 20 percent by weight to 90 percent by weight, preferably from 40 percent by weight to 80 percent by weight, and particularly preferably from 50 percent by weight to 60 percent by weight, based on the total weight of the polyol, monomer type A and monomer type B components.

Accordingly, it is conceivable that in the process for preparing the polymer composition, the prepolymer having the terminal NCO groups is present in an amount from 20 percent by weight to 90 percent by weight, preferably from 40 percent by weight to 80 percent by weight, and particularly preferably from 50 percent by weight to 60 percent by weight, based on the total weight of the prepolymer, monomer type A and monomer type B components.

In yet another embodiment, it may be provided that in the process for preparing the polymer composition, monomer type A is present in an amount of from 30 percent by weight to 95 percent by weight, preferably from 50 percent by weight to 90 percent by weight, and particularly preferably from 70 percent by weight to 85 percent by weight, based on the total weight of monomer type A and monomer type B.

It may further be possible that in the process for preparing the polymer composition, monomer type B is present in an amount of from 5 percent by weight to 70 percent by weight, preferably from 10 percent by weight to 50 percent by weight, and particularly preferably from 15 percent by weight to 30 percent by weight, based on the total weight of monomer type A and monomer type B.

According to a further advantage, it can be provided that the low-molecular-weight polymer has a number-average molecular weight of 3,000-200,000 g/mol, preferably of 5,000-100,000 g/mol, and particularly preferably of 10,000-60,000 g/mol.

From a second aspect, the invention relates to a polymer composition that is preparable or prepared by the process according to the invention.

The synthesis according to the invention of the silane-modified ethylene-based polymer in a polyol results in a polymer composition with improved properties compared to a silane-modified ethylene-based polymer that is synthesized in the PU prepolymer. Structurally, in the polymer composition according to the invention, the formation of an interpenetrating network is advantageous for the physico-chemical properties. It exhibits increased temperature resistance and also improved sealing properties against oil.

If the optional step (c) is carried out according to the invention, this polymer composition is characterized in that the polyol or the prepolymer is partially crosslinked with the low-molecular-weight polymer formed by radical polymerization.

Preferably, it may be provided that the polymer composition has a glass transition temperature of between −50-100° C., preferably between −30-70° C., and particularly preferably between 0-60° C.

A further advantage can be achieved within the scope of the invention if it has a viscosity of 5,000-25,000 mPa·s, and preferably of 7,000-21,000 mPa·s, measured at 90° C.

It can be advantageous if the polymer composition within the scope of the invention is free of solvents. The further reaction with a polyisocyanate to form a polyurethane thus produces a solvent-free PU polymer.

Another object of the invention is the use of the polymer composition according to at least one of the preceding claims as an adhesive, sealant, or coating agent. In particular, it is provided that the polymer composition cures as a one-component composition with moisture and by increasing the temperature to more than 100° C.

The invention also provides a process for producing a moisture-hardening polyurethane hot melt adhesive composition. The process includes the following steps:
a) Provision of a polymer composition according to the invention;
b) Addition of sufficient polyisocyanate in order to achieve the desired isocyanate content and isocyanate index and polymerization through the use of an additive polymerization process;
c) Optional addition of an aminosilane or a mercaptosilane and conversion to a silane-terminated polyurethane.

By synthesizing the silane-modified ethylene-based polymer in a polyol according to the invention, a polyurethane hot melt adhesive composition with improved properties is obtained through the use of the polymer composition according to the invention compared to a silane-modified ethylene-based polymer that is synthesized in the PU prepolymer. The PU hotmelt according to the invention has a higher temperature resistance, increased chemical resistance, and improved adhesion to inorganic materials. Furthermore, the resulting polymer composition exhibited improved sealing properties against oil.

Commercially available polyisocyanates, in particular diisocyanates, can be used as polyisocyanates for the production of the polyurethane polymer.

Further, it may be possible that the polyisocyanate is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl 4,4′ diisocyanate, azobenzene 4,4′ diisocyanate, diphenyl sulfone 4,4′ diisocyanate, dichlorohexamethylene diisocyanate, furfurylidene diisocyanate, 1-chlorobenzene-2,4-diisocyanate, 4,4′,4″ triisocyanato-triphenylmethane, 1,3,5-triisocyanato-benzene, 2,4,6-triisocyanato-toluene and 4,4′-dimethyldiphenylmethane-2,2′,5,5-tetraisocyanate, 3-isocyanate-methyl-3,5,5-trimethylcyclohexylisocyanate, 1,3-bis(isocyanatomethyl)benzene, 1,3-bis(isocyanatomethyl)cyclohexane, block diisocyanates and carbodiimide-modified polyisocyanates, as well as any mixtures of the above isocyanates.

Advantageously, within the scope of the invention it can be provided that in the process for producing a moisture-hardening polyurethane hot melt adhesive composition the free isocyanate content is between 0-20%, preferably between 0-15%, and particularly preferably between 0-10%.

According to a further possibility, it can be provided that in this process the isocyanate index is between 0.5-10, preferably between 1-3, and particularly preferably between 1.5-2.5.

According to the optional step (c), the moisture-hardening polyurethane hot-melt adhesive composition obtained in step (b) can be converted into a silane-terminated polyurethane by adding an aminosilane or a mercaptosilane.

According to the invention, an aminosilane or a mercaptosilane is used in step (c). This should be understood to mean that at least one aminosilane or one mercaptosilane can be used here, including two, three, four, or even more aminosilanes or mercaptosilanes. Preferably exactly one aminosilane or exactly one mercaptosilane is used in the process.

The aminosilane is preferably an aminosilane AS of formula (I).

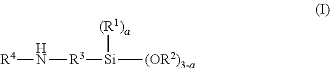

The radical R¹ represents a linear or branched, monovalent hydrocarbon radical with 1-12 carbon atoms, which optionally has one or more CC multiple bonds and/or optionally cycloaliphatic and/or aromatic moieties. In particular, R¹ represents a methyl, ethyl, or isopropyl group.

The radical R² represents an acyl radical or a linear or branched, monovalent hydrocarbon radical with 1-12 carbon atoms, which optionally has one or more CC multiple bonds and/or optionally cycloaliphatic and/or aromatic moieties. The radical R² preferably represents an acyl or alkyl group with 1-5 carbon atoms, in particular a methyl or an ethyl or an isopropyl group.

The radical R³ represents a linear or branched, divalent hydrocarbon radical with 1-12 carbon atoms, which optionally has cyclic and/or aromatic components and optionally one or more heteroatoms. The radical R³ preferably represents an alkylene radical with 1-3 carbon atoms, in particular with 3 carbon atoms.

Furthermore, index a stands for a value of 0, 1, or 2, in particular 0 or 1.

The radical R⁴ represents a hydrogen atom or a linear or branched hydrocarbon radical with 1-20 carbon atoms, which optionally has cyclic components, or represents a radical of the formula (II).

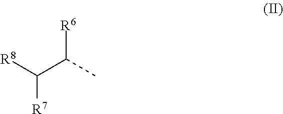

The radicals R⁶ and R⁷ independently represent a hydrogen atom or a radical from the group comprising —R⁹, —CN and —COOR⁹.

The radical R⁸ is hydrogen or a radical selected from the group consisting of —CH₂—COOR⁹, —COOR⁹, —CONHR⁹, —CON(R⁹)₂, —CN, —NO₂, —PO(OR⁹)₂, SO₂R⁹ and —SO₂OR⁹.

The radical R⁹ represents a hydrocarbon radical with 1 to 20 carbon atoms, optionally containing at least one heteroatom.

Examples of suitable aminosilanes AS of formula (I) are primary aminosilanes such as 3-aminopropyltrimethoxysilane, 3-aminopropyldimethoxymethylsilane, secondary aminosilanes such as N-butyl-3-aminopropyltrimethoxysilane, N-phenyl-3-aminopropyltrimethoxysilane, the products from Michael-type addition of primary aminosilanes such as 3-aminopropyltrimethoxysilane or 3-aminopropyldimethoxymethylsilane to Michael acceptors such as acrylonitrile, acrylic and methacrylic acid esters, acrylic or methacrylic acid amides, maleic and fumaric acid diesters, citraconic acid diesters and itaconic acid diesters, for example N-(3-trimethoxysilyl-propyl)-amino-succinic acid dimethyl esters and diethyl esters, as well as analogues of the above-mentioned aminosilanes with ethoxy or isopropoxy groups in place of the methoxy groups on the silicon. Particularly suitable aminosilanes AS are secondary aminosilanes, in particular aminosilanes AS, in which R4 in formula (I) is different from H. The Michael-type adducts, in particular N-(3-trimethoxysilyl-propyl)-amino-succinic acid diethyl ester, are preferred.

In the present document, the term “Michael acceptor” refers to compounds which, due to the double bonds they contain and activated by electron acceptor residues, are capable of entering into nucleophilic addition reactions with primary amino groups (NH₂ groups) in a manner analogous to the Michael addition (hetero-Michael addition).

In another aspect, the invention relates to a moisture-curable polyurethane hot-melt adhesive composition producible or prepared by the process disclosed above.

A further advantage can be achieved within the scope of the invention if the polyurethane hot-melt adhesive composition has a viscosity of 10 mPas to 150,000 mPas at 120° C. The viscosity is preferably between 1,000-100,000 mPas, more preferably between 3,000-75,000 mPas, and particularly preferable between 2,000-50,000 mPas.

Also an object of the invention is the use of the moisture-hardening polyurethane hot-melt adhesive composition of the invention as an adhesive, sealant, or coating agent. In particular, it is intended for use as an adhesive.

The invention also includes a process for the production of a 1K polyurethane adhesive comprising the following steps:
a) Provision of the polymer composition of the invention, in which, during its production, instead of increasing the temperature in optional step (c), the polymer is cooled to a temperature of 80° ° C. to 20° C.;
b) Addition of a polyisocyanate according to the invention to achieve a desired free isocyanate content and isocyanate index;
c) optional cooling to a temperature of 80° ° C. to 20° C. for a period of 0.5-5 hours.

Commercially available polyisocyanates, in particular diisocyanates, can be used as polyisocyanates for the production of the polyurethane polymer.

It may be further possible that the polyisocyanate is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate, 4,4′,4″-triisocyanato-triphenylmethane, 1,3,5-triisocyanato-benzene, 2,4,6-triisocyanato-toluene and 4,4′-dimethyldiphenylmethane-2,2′,5,5-tetraisocyanate, 3-isocyanate-methyl-3,5,5-trimethylcyclohexylisocyanate, 1,3-bis(isocyanatomethyl)benzene, 1,3-bis(isocyanatomethyl)cyclohexane, block diisocyanates and carbodiimide-modified polyisocyanates, polymeric diphenylmethane diisocyanate (PMDI), and any mixtures of the above isocyanates.

In a preferred embodiment, a diphenyl methane isocyanate (MDI) or polymeric diphenyl methane diisocyanate (PMDI) are used as the polyisocyanate.

The MDI can be a mixture of two or three of its isomers, namely 2,2′-diphenylmethane diisocyanate, 2,4′-diphenylmethane diisocyanate, or 4,4′-diphenylmethane diisocyanate. However, only one isomer can be used, which is then preferably the 4,4′-diphenylmethane diisocyanate.

Polymeric diphenylmethane diisocyanate (PMDI), also known as technical MDI, is a mixture of methylene diphenyl isocyanates and homologous aromatic polyisocyanates. However, the term “polymeric diphenylmethane diisocyanate” is actually technically incorrect, as it is not a polymer, but rather a mixture of compounds with several (typically up to 6) phenylene groups, each of which has an isocyanate group. A common trade name is also polymethylene polyphenyl isocyanate.

According to an advantageous further development of the invention, it can be provided that the free isocyanate content set in step (b) of the process is between 2-40%, preferably between 5-30%, and particularly preferably between 10-20%.

Furthermore, it is conceivable within the scope of the invention that the isocyanate index set in step (b) of the process is between 1.5-20, preferably between 2-15, and particularly preferably between 4-10.

In another aspect, the invention relates to a 1K polyurethane adhesive that can be produced or is produced by the process disclosed above.

According to a further possibility, it can be provided that the 1K polyurethane adhesive has a viscosity of 5,000-25,000 mPa·s, and preferably from 6,000-21,000 mPa·s, measured at 20° C.

Also an object of the invention is a use of the 1K polyurethane adhesive of the invention as an adhesive, coating compound, or sealant, in particular as a multi-purpose adhesive, assembly adhesive, construction adhesive, paper and packaging adhesive, film laminating adhesive, adhesive for ceramic and metallic materials, wood, glass, sandwich systems, textiles, reinforcing fabrics, materials in the field of aircraft, military, or shipbuilding.

In a further aspect, the invention relates to a polyurethane composition comprising
a) 5-90 percent by weight of a urethane polymer or urethane prepolymer prepared by additive polymerization of a polyisocyanate and a polyol;
b) 10-95 percent by weight of a low-molecular-weight polymer of ethylenically unsaturated monomers which do not contain active hydrogen, at least one of the monomers being an ethylenically unsaturated monomer having a siloxane group.

In one embodiment of the invention, the polyurethane composition is characterized in that the low-molecular-weight polymer consists of more than 50%, preferably more than 75%, and further preferably 100% of an ethylenically unsaturated monomer with a siloxane group.

In a preferred embodiment of the invention, the polyurethane composition is characterized in that the ethylenically unsaturated monomer with a siloxane group is a silane-modified acrylate.

In a second aspect, the invention relates to the use of an ethylenically unsaturated monomer with a siloxane group for copolymerization with ethylenically unsaturated monomers that do not contain active hydrogen in a polyol or in a prepolymer with the terminal NCO groups as a solvent.

In one embodiment of the invention, the use is characterized in that the ethylenically unsaturated monomer with a siloxane group is a silane-modified acrylate.

In an additional aspect, the invention relates to an acrylate copolymer comprising:
a) 5-95 percent by weight of one or more acrylate monomers that do not contain active hydrogen, preferably selected from the group consisting of butyl methacrylate and methyl methacrylate;
b) 5-95 percent by weight of one or more acrylate monomers with a siloxane side group, preferably a 3-methacryloxypropyltrimethoxysilane.

### Definitions

In the present document, substance names beginning with “poly” such as polyol or polyisocyanate refer to substances that formally contain two or more of the functional groups appearing in their name per molecule.

In the present document, the term “polymer” includes not only a collective of chemically uniform but differing macromolecules in terms of degree of polymerization, molar mass and chain length, which has been produced by a polyreaction (polymerization, polyaddition, polycondensation), but also derivatives of such a collective of macromolecules from polyreactions, i.e., compounds obtained by conversions, such as additions or substitutions, of functional groups on given macromolecules, which may be chemically uniform or chemically non-uniform. The term also includes copolymers and so-called prepolymers, i.e., reactive oligomeric pre-adducts whose functional groups are involved in the formation of macromolecules.

The term “copolymer” as used herein refers to a polymer that is composed of two or more different monomer units. This means that the copolymer differs from a homopolymer, which is made up of only one type of monomer (real or assumed) and therefore only has one repeating unit. Copolymers can be divided into five classes:
1.) statistical copolymers in which the distribution of the two monomers in the chain follows a statistical distribution,
2.) gradient copolymers, which are similar in principle to random copolymers, but in which the proportion of one monomer increases and the proportion of the other decreases over the course of the chain,
3.) alternating copolymers, in which the two monomers alternate,
4.) block copolymers and segment copolymers, which consist of longer sequences or blocks of each monomer,
5.) graft copolymers, in which blocks of one monomer are grafted onto the backbone of another monomer.

The term “low-molecular-weight polymer” in this document refers to a polymer with a number-average molecular weight of 200,000 g/mol or less.

The term “polyurethane polymer” includes all polymers that are produced using the so-called diisocyanate polyaddition process. This also includes polymers that are almost or completely free of urethane groups. Examples of polyurethane polymers are polyether polyurethanes, polyester polyurethanes, polyether polyureas, polyureas, polyester polyureas, polyisocyanurates, and polycarbodiimides.

In this document, an “active hydrogen” is understood to mean a hydrogen bound to N, O, or S (also referred to synonymously as “Zerewitinoff active hydrogen”) if it produces methane by reaction with methyl magnesium iodide according to a process discovered by Zerewitinoff. Typical examples of compounds with active hydrogen are compounds that contain carboxyl, hydroxyl, amino, imino, or thiol groups as functional groups.

Accordingly, the monomer that does not contain active hydrogen (monomer type B) is a monomer that does not have any carboxyl, hydroxyl, amino, imino, or thiol groups.

According to the present application, a “functional group” is a group of atoms in an organic compound that significantly determines the material properties and the reaction behavior of the compound carrying it. Chemical compounds that carry the same functional groups are grouped into substance classes due to their often similar properties.

In this document, a “moisture-reactive functional group” is understood to mean a functional group that reacts with water. This reaction can lead to the crosslinking of two or more such groups and thus lead to the hardening of the corresponding polymer. In the field of polymers, qualified experts are familiar with moisture-reactive (curable) groups. Examples include the silane group and the isocyanate group.

In the present document, the terms “silane” and “organosilane” refer to compounds which have not only at least one, usually two, or three, alkoxy groups or acyloxy groups bonded directly to the silicon atom via Si—O bonds, but also at least one organic radical bonded directly to the silicon atom via an Si—C bond. Such silanes are also known to qualified experts as organoalkoxysilanes or organoacyloxysilanes.

Accordingly, the term “silane group” refers to the silicon-containing group bound to the organic residue of the silane bound via the Si—C bond. The silanes or their silane groups, respectively, hydrolyze upon contact with moisture and are therefore among the moisture-reactive groups.

“Aminosilanes” or “mercaptosilanes” are organosilanes whose organic residue has an amino group or a mercapto group. “Primary aminosilanes” are aminosilanes that have a primary amino group, i.e., an NH₂ group that is bound to an organic residue. “Secondary aminosilanes” are aminosilanes that have a secondary amino group, i.e., an NH group that is bonded to two organic residues.

In this document, “molecular weight” means the molar mass (in grams per mole or in Daltons) of a molecule. In this document, “average molecular weight” is always understood to mean the number-average of the molecular weight distribution Mₙ (number average). The term “number-average molecular weight” is also used as a synonym for “average molecular weight.”

The term “polymeric diphenylmethane diisocyanate” (PMDI) refers to a substance mixture of methylene diphenyl isocyanates and homologous aromatic polyisocyanates. The term “polymeric diphenylmethane diisocyanate” is a misnomer from a chemical perspective, as it is not a polymer, but rather a mixture of compounds with several (typically up to 6) phenylene groups, each of which has an isocyanate group. A common trade name is also polymethylene polyphenyl isocyanate.

For the purposes of the present application, a “chain transfer agent” is defined as an organic molecule capable of performing chain transfer. A chain transfer reaction is a reaction in the course of a chain polymerization in which the activity of a growing polymer chain is transferred to another molecule. Chain transfer reactions reduce the average degree of polymerization of the finished polymer. Qualified experts are familiar with chain transfer agents for radical polymerizations.

In this document, the term “solvent” is understood to mean compounds as listed as organic solvents in CD Römpp Chemie Lexikon, 9th edition, version 1.0, Georg Thieme Verlag, Stuttgart 1995. The polyols or prepolymers with terminal NCO groups used according to the invention are not covered by this definition, although they act as solvents for the monomers and also the low-molecular-weight polymer formed by radical polymerization.

In the present document, “solid” means substances that do not change their shape without external influence or are difficult to deform, but in particular they are not flowable. Accordingly, “liquid” refers to substances that can be deformed and flow, which also includes highly viscous and pasty substances.

In this document, “one-component” (abbreviated as “1K”) refers to a composition in which all components of the composition are stored mixed in the same container and which is curable with moisture. In the present document, “two-component” refers to a composition in which the components of the composition are present in two different components, which are stored in separate containers. Only shortly before or during application of the composition are the two components mixed together, whereupon the mixed composition hardens, with the hardening only taking place or being completed through the action of moisture.

It should be expressly pointed out that in the context of the present patent application, indefinite articles and indefinite numbers such as “one . . . .” “two . . . ” etc. should generally be understood as minimum information, i.e., as “at least one . . . ,” “at least two . . . ” etc., unless it is clear from the context or the specific text of a particular passage that only “exactly one . . . .” “exactly two . . . ” etc. is meant. Furthermore, all numerical indications as well as indications of process parameters and/or device parameters are to be understood in the technical sense, i.e., as having the usual tolerances. In addition, the explicit indication of the restriction “at least” or “at a minimum” or similar should not give rise to the assumption that the simple use of “one,” i.e., without the indication of “at least” or similar, means “exactly one.”

Unless otherwise stated, the percentages in this document are percentages by weight.

The embodiments shown here represent only examples of the present invention and should therefore not be construed as limiting. Alternative embodiments contemplated by qualified experts are equally included within the scope of the present invention.

### IMPLEMENTATION EXAMPLES

### 1. Preparation of a Polymer Composition According to the Invention

Based on the polymerization of acrylate polymers in polyols, a base formulation according to Table 1 was modified by using acrylate silanes. An organofunctional 3-methacryloxypropyltrimethoxysilane was used at 5%. 10%, and 12.5%.

In order to be able to produce a silane-modified acrylate polymer, the sample is heated to 90° C. in a glass reactor under a nitrogen atmosphere. After 30 minutes, the monomers are metered in over 2 hours at 90° ° C. and the initiator is added. The secondary reaction then takes place within 2 hours with the further addition of the initiator.

TABLE 1
Basic formulation and modifications of IC406-23

| | Proportion [%] | | | |
|---|---|---|---|---|
| | | 1: | 2: | 3: |
| | Reference | Reference | Reference | Reference |
| | (without | with 5% | with 10% | with 12.5% |
| Raw materials | silane) | silane | silane | silane |

Sample

| | | | | |
|---|---|---|---|---|
| PPG 2000 | 57.7 | 57.7 | 57.7 | 57.7 |
| N-BMA | 8.6 | 7.6 | 6.6 | 6 |
| MMA | 3.2 | 2.8 | 2.4 | 2.2 |
| Silane | 0 | 1.4 | 2.8 | 3.6 |
| Dodecyl mercaptan | 0.2 | 0.2 | 0.2 | 0.2 |
| Dilauroyl peroxide | 0.2 | 0.2 | 0.2 | 0.2 |

Dosage

| | | | | |
|---|---|---|---|---|
| Dilauroyl peroxide | 0.1 | 0.1 | 0.1 | 0.1 |
| N-BMA | 21.8 | 19.3 | 16.7 | 15.2 |
| MMA | 8.1 | 7.1 | 6.1 | 5.6 |
| Silane | 0 | 3.5 | 7.1 | 9.1 |
| Dilauroyl peroxide | 0.1 | 0.1 | 0.1 | 0.1 |

(PPG-2000 = polypropylene glycol
MW = 2000;
N-BMA = butyl methacrylate;
MMA = methyl methacrylate;
silane = 3-methacryloxypropyltrimethoxysilane)

The rheological analyzes showed that the 5% use of silane hardly changed the basic properties of the acrylate (see Table 2). By increasing the ratio of silane up to 12.5%, the material becomes significantly less viscous and can even flow at room temperature.

TABLE 2
Rheological characteristics of silane-
modified acrylate polymers in polyol

| | Viscosity | | Internal | |
|---|---|---|---|---|
| | @ 120° C. | @ 140° C. | cohesion G′ | tan |
| Trials | (mPas) | (mPas) | 20° C. | Delta = 1 |
| Reference: | 5,359 | 3,265 | 0.01 | 34° C. |
| Acrylate* | | | | |
| without | | | | |
| silane | | | | |
| 1: Acrylate* | 5,332 | 3,265 | 0.01 | 27° C. |
| with 5% | | | | |
| silane | | | | |
| 2: Acrylate* | 3,626 | 2,487 | 0.01 | 21° C. |
| with 10% | | | | |
| silane | | | | |
| 3: Acrylate* | 1,749 | 1,100 | 0.00 | 11° C. |
| with 12.5% | | | | |
| silane | | | | |

*Acrylate = IC406-23

IC406-23 was modified with different concentrations of 3-methacryloxypropyltrimethoxysilane in order to subsequently produce moisture-hardening PU adhesives. Interestingly, it was found that when the silane content is higher in the acrylate content, a viscosity-reducing effect occurs even when used to produce polyurethane hot melts, and that the addition of plasticizers can be foregone.

### Example 1 Liquid PUR Adhesive

IC406-23 was calculated to have a glass transition temperature of 40° ° C. modified with 12.5% 3-methacryloxypropyltrimethoxysilane and polymerized in PPG 4000 (PCC Rokita Rokopol DE4020) (IC1760-5 with PPG 4000). This was then converted into the polyurethane adhesive IC1701-45 (Table 2).

TABLE 2
Formulation of IC1701-45

| Raw | Proportion |
|---|---|
| materials | [%] |
| IC1760-5 | 47.6 |
| PPG 4000 | 7 |
| DMDEE | 0.4 |
| pMDI | 45 |

Table 3 below compares the properties of IC1701-45 with a commercially available 1-component PUR adhesive IC1701-22. This shows the significantly increased performance of the silane acrylate-modified system for the adhesion of wood.

TABLE 3
Characteristics of IC1701-22 & IC1701-45

| | Viscosity | | | | | open |
|---|---|---|---|---|---|---|
| | @ 20° C. * | NCO | D1** | D4** | WATT91*** | time**** |
| Designation | [mPas] | content [%] | [N/mm²] | [N/mm²] | [N/mm²] | [min] |
| IC 1701-22 | 6000 | 11 | 11.1 | 4.52 | 5.8 | 25-30 |
| IC 1701-45 | 7600 | 13.3 | 17 | 7.11 | 8.21 | 10 |

* Brookfield DVII, Sp. 6. 20 rpm;
**DIN EN 204;
***DIN EN 14257
****internal process: A 300 μm polymer film is applied to a soda kraft paper strip (60 × 8 cm) and paper strips (9 × 2 cm) are pressed on with finger pressure at defined time intervals (e.g., 1, 2, etc. minutes). After crosslinking, the paper strips are removed and evaluated. The time in which at least 70% of the paper remains adhered to the adhesive film is recorded.

### Example 2 PUR Hot Melt Adhesive (Textile)

IC406-23 was calculated to have a glass transition temperature of −6° C., modified with 12.5% 3-methacryloxypropyltrimethoxysilane and polymerized in PPG 1000 (PCC Rokita Rokopol D1002) (IC1760-6). This was then converted into the polyurethane adhesive IC768-3 (Table 4).

In order to produce a polyurethane adhesive, further polyols and additives are added to the silane-modified acrylate IC1760-6 at 90° C. and homogenized for 45 minutes at approx. 10 mbar. The 4,4′-MDI is then added and stirred for 60 minutes. Before the polyurethane adhesive is filled, it is degassed again at approx. 10 mbar.

TABLE 4
Formulation of IC768-3

| Raw | Proportion |
|---|---|
| materials | [%] |
| IC1760-6 | 51.73 |
| PPG Triol | 11.75 |
| PPG 400 | 13.98 |
| Additives | 0.51 |
| 4,4′-MDI | 22.04 |

The following table compares the properties of IC768-3 with a PUR hot melt adhesive (textile). This shows a significant increase in the internal strength (cohesion) of the silane acrylate-modified variant.

TABLE 5
Characteristics of IC764-42 & IC768-3

| | | Viscosity | | | Internal | tan |
|---|---|---|---|---|---|---|
| | w(NCO) | @ 90° C. | @ 120° C. | @ 140° C. | Cohesion | delta = |
| Trials | [%] | [mPas] | [mPas] | [mPas] | G′ 20° C. | 1 |
| IC764-42 | 2.3 | 21,200 | 5,912 | 3,300 | 0.02 | 2° C. |
| IC768-3 | 1.6 | 53,000 | 15,000 | 7,600 | 0.06 | 9° C. |

### Measuring Process for Determining Internal Cohesion G′ and tan Delta:

An oscillation measurement depending on the temperature (160 to −20° C.) was carried out using the Modular Compact Rheometer 301 (Anton Paar). G′ & G″ and the ratio (tan delta) to each other are recorded at each temperature. G′ describes the solid portion and G″ the liquid portion of a material. The “Internal Cohesion G” at 20° C. describes the solid proportion of the material or how high the cohesion is. If G′ and G″ are equal, then tan Delta=1. This occurs at a certain temperature, which is then read. At this temperature a state is described in which the material is neither a liquid nor a solid. If the temperature is reduced further, ideally a “solid” exists.

### Example 3: Production of a PUR Hot Melt Adhesive (Textile)

In order to be able to produce a prepolymer with terminal isocyanate (NCO) groups IC768-15 (see Table 6), a polyol mixture is heated to 120° C. and homogenized for 45 minutes at approx. 10 mbar. The 4,4′-MDI is then added and stirred under a nitrogen atmosphere for 60 minutes.

TABLE 6
Formulation of prepolymer IC768-15

| Raw materials | Proportion [%] |
|---|---|
| PPG 1000 | 59.0 |
| PPG 400 | 7.9 |
| 4,4′-MDI | 33.1 |
| [NCO]/[OH] | 1.7:1 |

(PPG 1000 = polypropylene glycol
Mn = 1000;
PPG 400 = polypropylene glycol
Mn = 400;
4,4′-MDI = 4,4′-diphenylmenthane diisocyanate;
[NCO]/[OH] = molar ratio of NCO to OH groups in the prepolymer obtained).

In order to be able to subsequently produce a silane-modified acrylate polymer IC768-17 (see Table 7) in the prepolymer IC768-15, the IC768-15 is cooled to 70° C. After adding a portion of the monomers, the initiator and the chain transfer agent, the mixture is heated to 90° C. After 30 minutes, the monomers are metered in over the course of 2 hours at 90° C. and the initiator is added again. The secondary reaction then takes place within 2 hours with the further addition of the initiator. The PUR hot melt adhesive can then be filled at 90° C.

In order to be able to investigate possible undesirable side reactions during polymerization with the prepolymer IC768-15 (see Table 7) in more detail, a reference synthesis is necessary. The PPG 1000 (see Table 6) was chosen as sample instead of the prepolymer IC768-15 and thus represents IC1760-9 (see Table 7). After polymerization, it is converted into a polyurethane adhesive IC768-7 (see Table 8) with the addition of PPG 400 and 4,4′-MDI, as already described in Example 2.

TABLE 7
Formulation of IC768-17 & IC1760-9

| Trial number | IC768-17 | IC1760-9 |
|---|---|---|
| Raw materials | Proportion [%] | |

Sample:

| | | |
|---|---|---|
| PPG 1000 | — | 57.7 |
| IC768-15 | 69.9 | — |
| BA | 3.1 | 4.4 |
| MMA | 2.8 | 3.9 |
| Silane | 2.5 | 3.5 |
| Dodecyl mercaptan | 0.13 | 0.2 |
| Dilauroyl peroxide | 0.13 | 0.2 |

Dosage

| | | |
|---|---|---|
| Dilauroyl peroxide | 0.07 | 0.1 |
| BA | 7.9 | 11.1 |
| MMA | 7.0 | 9.8 |
| Silane | 6.4 | 9.0 |
| Dilauroyl peroxide | 0.07 | 0.1 |

(BA = butyl acrylate;
MMA = methyl methacrylate;
silane = 3-methacryloxypropyltrimethoxysilane)

TABLE 8
Formulation of IC768-7

| Raw materials | Proportion [%] |
|---|---|
| IC1760-9 | 71.3 |
| PPG 400 | 5.5 |
| 4,4′-MDI | 23.2 |
| [NCO]/[OH] | 1.7 |

The product analysis (see Table 9) indicates that the polymerization of silane-modified acrylate polymer takes place independently in the presence of reactive isocyanate groups: The measurement results are within the tolerance limits of the product specification.

TABLE 9
Characteristics of IC768-17 vs IC768-7

| | | Viscosity | | | |
|---|---|---|---|---|---|
| | | @ | @ | Internal | tan |
| | w(NCO) | 120° C. | 140° C. | cohesion | delta = |
| Trials | [%] | [mPas] | [mPas] | G′ 20° C. | 1 |
| IC768-7 | 3.4 | 4,100 | 2,900 | 0.01 | — |
| IC768-17 | 3.2 | 5,900 | 4,700 | 0.01 | — |

1. A process for producing a polymer composition comprising the following steps:
a) Combination of:
(i) a polyol or a prepolymer with terminal isocyanate (NCO) groups
(ii) an ethylenically unsaturated monomer containing no active hydrogen and having no moisture-reactive functional groups (monomer type A), and
(iii) an ethylenically unsaturated monomer containing no active hydrogen and having a moisture-reactive functional group (type B monomer);
b) polymerize the mixture from step (a) using a radical polymerization process with a chain transfer agent to obtain a low-molecular-weight polymer;
c) optional heating of the mixture from step (b) to a temperature of 100-160° C. for 10-60 minutes to partially crosslink the polyol or the prepolymer with the terminal NCO groups with the low-molecular-weight polymer.

2. Process according to claim 1, characterized in that the polyol is selected from the group consisting of polyester, hydroxyl group-containing polycaprolactone, polyoxyalkene polyol, monosubstituted glycol ester, polythioether, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy functional fats and oils, and mixtures thereof, wherein the polyol is preferably a diol, a polyethylene oxide, or a polypropylene oxide.

3. Process according to claim 1, characterized in that monomer type A is selected from the group consisting of C1 to C12 esters of acrylic acid or methacrylic acid such as methyl acrylate, ethyl acrylate, n-butyl acrylate, methyl methacrylate, ethyl methacrylate or n-butyl methacrylate, vinyl esters such as vinyl acetate or vinyl propionate, vinyl ethers, fumarates, maleates, styrenes, acrylonitriles, ethylenes, or mixtures thereof, wherein monomer type A is preferably n-butyl methacrylate (n-BMA) or methyl methacrylate (MMA) or a mixture thereof.

4. Process according to claim 1, characterized in that monomer type B is selected from the group consisting of vinyl compounds, acrylates, methacrylates, fumarates, maleates, styrenes, acrylonitriles, ethylenes, or mixtures thereof, having a moisture-reactive functional group, which is preferably a silane group.

5. Process according to claim 4, characterized in that monomer type B is selected from the group consisting of vinyltrichlorosilane, methylvinyldichlorosilane, vinyltriethoxysilane, vinyltrimethoxysilane, vinyltris(2-methoxyethoxy)silane, vinyltriacetoxysilane, vinylmethyldiethoxysilane, vinyldimethylethoxysilane, vinylmethyldimethoxysilane, vinyldimethylmethoxysilane, vinylmethyldiacetoxysilane, vinyltriisopropoxysilane, vinyltriisopropenoxysilane, vinyltris(methylethylketoximino)silane, divinyltetramethyldisiloxane, tetravinyltetramethylcyclotetrasiloxane, 3-acryloxypropyldimethylmethoxysilane, 3-acryloxypropyldimethylethoxysilane, 3-acryloxypropyltrimethoxysilane, 3-acryloxypropyltriethoxysilane, 3-methacryloxypropyltrimethoxysilane, 3-methacryloxypropyltriethoxysilane, 3-methyacryloxypropylmethyldiethoxysilane, 3-methyacryloxypropylmethyldimethoxysilane, 3-methacryloxypropyltris(2-methoxyethoxy)silane, 4-(3-trimethoxysilylpropyl)benzylstyrenesulfonate, allyltriethoxysilane, allyltrimethoxysilane and oligomers of these silanes, monomer type A being preferably methacryloxypropyltrimethoxysilane.

6. Process according to claim 1, characterized in that the initiator used in the radical polymerization process is a peroxide initiator or an azo initiator, which is preferably selected from the group consisting of dilauroyl peroxide, dibenzoyl peroxide, and azobis (isobutyronitrile).

7. Process according to claim 1, characterized in that the chain transfer agent is an organohalogen compound, an unsaturated aromatic compound or a thiol, which is preferably selected from the group consisting of tetrachloromethane, 2,4-diphenyl-4-methyl-1-pentene, dodecyl mercaptan (DDM), thioglycolic acid, octylthioglycolate, and thioglycerol, and particularly preferably dodecyl mercaptan.

8. Process according to claim 1, characterized in that the polyol or the prepolymer with terminal NCO groups is obtained in an amount of 20 percent by weight to 90 percent by weight, preferably from 40 percent by weight to 80 percent by weight and particularly preferably from 50 percent by weight to 60 percent by weight on the total weight of the components polyol or prepolymer, monomer type A and monomer type B.

9. Process according to claim 1, characterized in that monomer type A in an amount of 30 percent by weight to 95 percent by weight, preferably from 50 percent by weight to 90 percent by weight and particularly preferably from 70 percent by weight to 85 percent by weight, based on the total weight of monomer type A and monomer type B is present.

10. Process according to claim 1, characterized in that monomer type B in an amount of 5 percent by weight to 70 percent by weight, preferably from 10 percent by weight to 50 percent by weight and particularly preferably from 15 percent by weight to 30 percent by weight, based on the total weight of monomer type A and monomer type B is present.

11. Process according to claim 1, characterized in that the low-molecular-weight polymer has a number-average molecular weight of 3,000-200,000 g/mol, preferably of 5,000-100,000 g/mol and particularly preferably of 10,000-60,000 g/mol.

12. Polymer composition prepared by a process according to claim 1.

13. Polymer composition according to claim 12, characterized in that the polymer composition has a glass transition temperature of between −50-100° C., preferably between −30-70° C., and particularly preferably between 0-60° C.

14. Polymer composition according to claim 12, characterized in that the polymer composition has a viscosity of 5,000-25,000 mPa·s, and preferably from 7,000-21,000 mPa·s, measured at 90° C.

15. Polymer composition according to claim 12, characterized in that it is free of solvents.

16. Use of the polymer composition according to claim 12 as an adhesive, sealant, or coating agent, wherein the polymer composition cures as a one-component composition with moisture and by increasing the temperature to more than 100° C.

17. A process for producing a moisture-hardening polyurethane hot melt adhesive composition comprising the following steps:
a) Provision of a polymer composition according to claim 12;
b) Addition of sufficient polyisocyanate in order to achieve the desired isocyanate content and isocyanate index and polymerization through the use of an additive polymerization process;
c) Optional addition of an aminosilane or a mercaptosilane and conversion to a silane-terminated polyurethane.

18. Process according to claim 17, characterized in that the polyisocyanate in step b) is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl 4,4′ diisocyanate, azobenzene 4,4′ diisocyanate, diphenyl sulfone 4,4′ diisocyanate, dichlorohexamethylene diisocyanate, furfurylidene diisocyanate, 1-chlorobenzene-2,4-diisocyanate, 4,4′,4″-triisocyanato-triphenylmethane, 1,3,5-triisocyanato-benzene, 2,4,6-triisocyanato-toluene and 4,4′-dimethyldiphenylmethane-2,2′,5,5-tetraisocyanate, 3-isocyanate-methyl-3,5,5-trimethylcyclohexylisocyanate, 1,3-bis(isocyanatomethyl)benzene, 1,3-bis(isocyanatomethyl)cyclohexane, polymeric diphenylmethane diisocyanate (PMDI), block diisocyanates and carbodiimide-modified polyisocyanates, and mixtures thereof.

19. Process according to claim 17, characterized in that the free isocyanate content is between 0-20%, preferably between 0-15%, and particularly preferably between 0-10%.

20. Process according to claim 17, characterized in that the isocyanate index is between 0.5-10, preferably between 1-3, and particularly preferably between 1.5-2.5.

21. Moisture-hardening polyurethane hot-melt adhesive composition prepared by a process according to claim 17.

22. Moisture-hardening polyurethane hot-melt adhesive composition according to claim 21, characterized in that the composition has a viscosity of 10-150,000 mPas at 120° C.

23. Use of the moisture-hardening polyurethane hot-melt adhesive composition according to claim 21 as an adhesive, sealant, or coating agent.

24. The process for producing a 1K polyurethane adhesive includes the following steps:
a) Provision of a polymer composition according to claim 1, wherein instead of increasing the temperature in optional step (b), the polymer is cooled to a temperature of 80° C. to 20° C.;
b) Addition of a polyisocyanate to achieve a desired free isocyanate content and isocyanate index;
c) optional cooling to a temperature of 80° C. to 20° C. for a period of 0.5-5 hours.

25. Process according to claim 24, characterized in that in step (b) a polyisocyanate according to claim 18 is used, the polyisocyanate preferably being a diisocyanate.

26. Process according to claim 24, characterized in that the free isocyanate content is between 2-40%, preferably between 5-30%, and particularly preferably between 10-20%.

27. Process according to claim 24, characterized in that the isocyanate index is between 1.5-20, preferably between 2-15, and particularly preferably between 4-10.

28. 1K polyurethane adhesive produced by a process according to claim 24.

29. 1K polyurethane adhesive according to claim 28, characterized in that the 1K polyurethane adhesive has a viscosity of 5,000-25,000 mPa·s, and preferably from 6,000-21,000 mPa·s, measured at 90° C.

30. Use of a 1K polyurethane adhesive according to claim 28 as an adhesive, coating compound, or sealant, in particular as a multi-purpose adhesive (household adhesive), assembly adhesive, construction adhesive, paper and packaging adhesive, film laminating adhesive, adhesive for ceramic and metallic Materials, wood, glass, sandwich systems, textiles, reinforcement fabrics, materials in the areas of aircraft, military, or shipbuilding.
